(19) United States
(12) Patent Application Publication
(10) Pub. No.: US 2019/0357747 A1
(43) Pub. Date: Nov. 28, 2019

(54) DOCKING ASSEMBLY FOR ROBOTIC VACUUMS

(71) Applicant: Louis C. Keiler, III, Wilmette, IL (US)

(72) Inventor: Louis C. Keiler, III, Wilmette, IL (US)

(21) Appl. No.: 16/416,870

(22) Filed: May 20, 2019

Related U.S. Application Data
(60) Provisional application No. 62/674,662, filed on May 22, 2018.

(51) Int. Cl. A47L 9/28; H02J 7/00

(52) U.S. Cl. CPC A47L 9/2873; A47L 2201/022; H02J 7/0042

(57) ABSTRACT

A docking assembly for robotic vacuums is disclosed that includes a lower base configured to retain a charging station for a robotic vacuum and an upper shelf located substantially above the lower base. During operation, the robotic vacuum may dock with its charging station between the upper shelf and lower base. In some embodiments, the upper shelf may support a trash bin, thereby allowing users to empty the robotic vacuum as needed. In further embodiments, the upper shelf may support a storage container that can be used to store excess lengths of the power cord of the charging station and/or accessories for the robotic vacuum. In further embodiments, the upper shelf may support a receptacle for other cleaning implements such as a mop. In further embodiments, the upper shelf may support a mechanism to feed and water animals.

### RELATED APPLICATION

This application claims priority to U.S. Provisional Patent Application No. 62/674,662, filed on May 22, 2018, entitled “DOCKING ASSEMBLY FOR ROBOTIC VACUUMS” by Dr. Louis C. Keiler, III, the contents of which are incorporated by reference herein.

### TECHNICAL FIELD

The present disclosure relates generally to data management systems and, more particularly, to systems and methods that manage agricultural data.

### BACKGROUND

Robotic vacuums are becoming increasingly popular and represent a convenient alternative to traditional vacuums that must be moved by hand. Notably, most robotic vacuums include a series of sensors and actuators that allow the vacuum to operate autonomously and without human intervention. For example, a robotic vacuum may sense an obstacle on the floor undergoing vacuuming and navigate around the obstacle. When the vacuuming task is complete, a typical robotic vacuum will return to its charging station and enter into an idle mode, while the charging station provides charge to the battery of the robotic vacuum.

The low form factor of a typical charging station for a robotic vacuum, as well as its power cord running to a wall socket, represent a potential tripping hazard. This is particularly true with fixed length cords that can become uncoiled over time. The potential tripping hazard also increases if accessories for the vacuum, such as replacement brushes and filters, are stored on the floor in close proximity to the vacuum charging station.

### SUMMARY

According to various embodiments, a docking assembly for robotic vacuums is disclosed that includes a lower base configured to retain a charging station for a robotic vacuum and an upper shelf located substantially above the lower base. During operation, the robotic vacuum may dock with its charging station between the upper shelf and lower base. In some embodiments, the upper shelf may support a trash bin, thereby allowing users to empty the robotic vacuum as needed. In further embodiments, the upper shelf may support a storage container that can be used to store excess lengths of the power cord of the charging station and/or accessories for the robotic vacuum. In another embodiment, the upper shelf may support a receptacle for other cleaning implements, such as a mop. In a further embodiment, the upper shelf may support a dish, tray, or other receptacle for feeding an animal (e.g., a water or food bowl for a dog, etc.).

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1C illustrate an example docking assembly for robotic vacuums, according to various embodiments;

FIGS. 2A-2B illustrate an example stand for a docking assembly, according to various embodiments;

FIGS. 3A-3B illustrate an example stand base for a docking assembly, according to various embodiments;

FIG. 4 illustrates an example charging station for a robotic vacuum, according to various embodiments; and

FIGS. 5A-5E illustrate an example prototype of a docking assembly for a robotic vacuum, according to various embodiments.

In the figures, reference numbers refer to the same or equivalent parts of the present invention throughout the several figures of the drawing.

### DESCRIPTION OF EXAMPLE EMBODIMENTS

According to the techniques described herein, systems and methods are disclosed that eliminate the potential tripping hazard represented by typical robotic vacuum charging stations. In addition, the techniques herein also allow for the convenient storage of vacuum accessories near the vacuum and emptying of the vacuum.

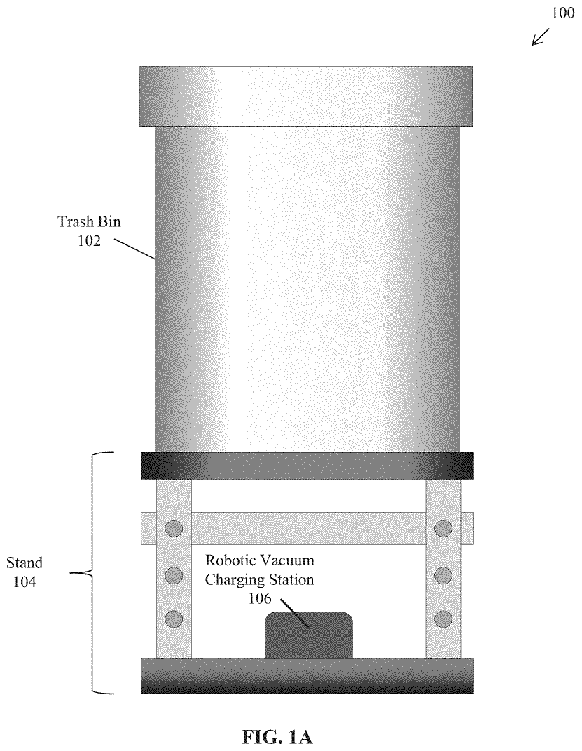

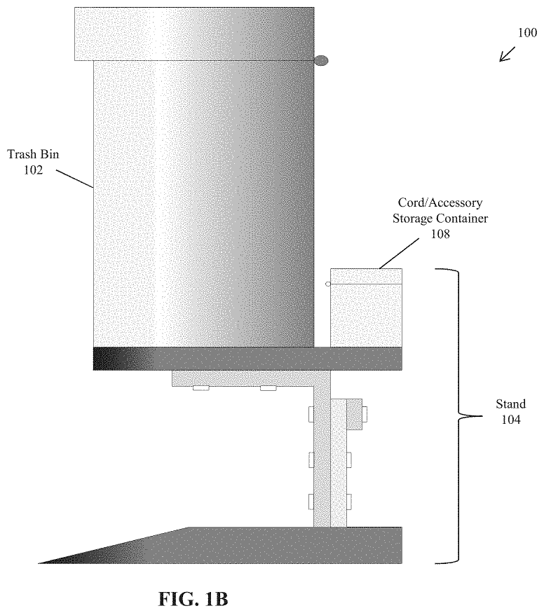

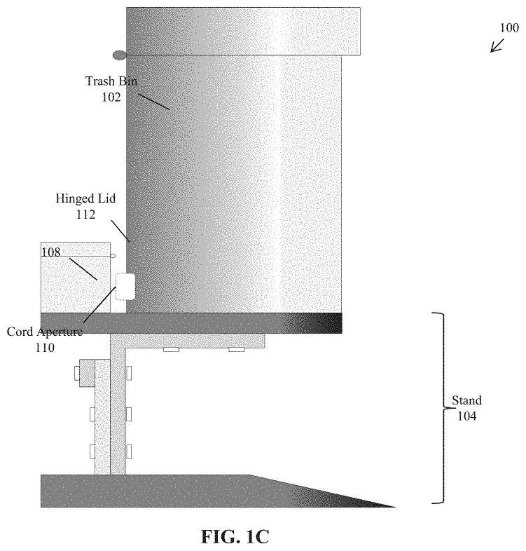

FIGS. 1A-1C illustrate an example docking assembly 100 for robotic vacuums, according to various embodiments. In particular, FIG. 1A illustrates an example front view of docking assembly 100. At the core of assembly 100 is a stand 104 that may, in some embodiments, support a trash bin 102. Assembly 100 may also optionally include a robotic vacuum charging station 106 located between opposing ends of stand 104 and configured to provide charge to a docked robotic vacuum. In another embodiment, the trash bin may be replaced a mechanism to feed and/or water animals, or a tray to rest a power mop.

FIGS. 1B and 1C illustrate side views of docking assembly 100. As shown, assembly 100 may include a cord and/or accessory storage container 108. As shown in FIG. 1C, particularly, container 108 may include a hinged lid 112, which can be opened to allow a user access to the contents of container 108. In some embodiments, container 108 may also define a cord aperture 110 that allows for storage of excess lengths of a charging cord of charging station 106 within container 108 during use. Other embodiments of container 108 may include other access means, such as drawers or the like, in lieu of hinged lid 112, or in conjunction therewith. In yet another embodiment, container 108 may include one or more receptacles to hold additional portable vacuums or other cleaning implements, such as a bagless stick vacuum, handheld vacuum (e.g. dust-buster), broom, Swifter™, mop, or the like.

Container 108 and/or trash bin 102 may be fastened to stand 104 via adhesives, bolts, screws, or any other suitable means to couple either or both of them to stand 104. In other embodiments, container 108 and/or trash bin 102 may be formed directly as part of stand 104 or may be removably coupled thereto (e.g., via a latching mechanism, the coupling of one or more posts to one or more apertures, etc.).

Five possible configurations are possible with respect to docking assembly 100:
1.) Assembly 100 includes trash bin 102 and storage container 108;
2.) Assembly 100 includes only storage container 108;
3.) Assembly 100 includes neither trash bin 102 nor storage container 108;
4.) Assembly 100 includes a station for a power mop; or,
5.) Assembly 100 includes a mechanism to feed and/or water an animal.

Depending on the configuration selected for implementation, trash bin 102 and storage container 108 may be sized appropriately, as desired. For example, if both trash bin 102 and storage container 108 are included in assembly 100, storage container 108 may be sized to consume some or all of the remainder of the area available on top of stand 104 after positioning of trash bin 102. Conversely, if assembly 100 includes only storage container 108, storage container 108 may be sized to consume some or all of the area of the upper portion of stand 104.

The relative positions of trash bin 102 and storage container 108 with one another may also be varied, in various embodiments. For example, while FIGS. 1A-1C depict trash bin 102 being substantially in front of storage container 108 (e.g., trash bin 102 faces the user during use), other embodiments contemplate arrangements whereby storage container 108 is instead located in front of trash bin 102, alongside of trash bin 102, or even underneath trash bin 102 as a secondary layer between stand 104 and trash bin 102.

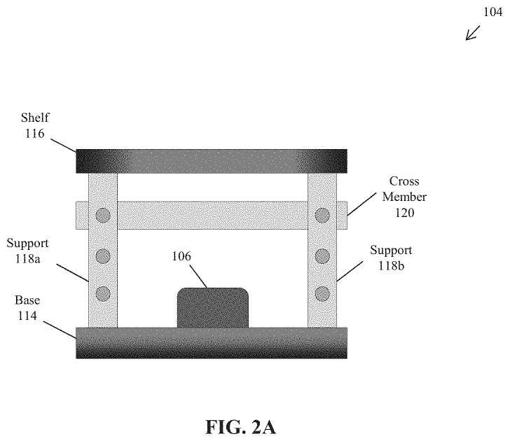

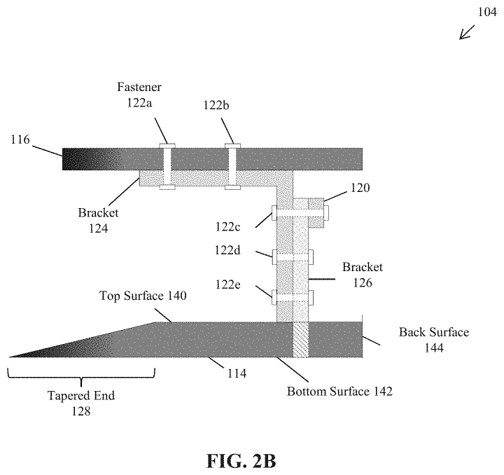

FIGS. 2A-2B illustrate front and side views of stand 104, respectively, in various embodiments. A front view of stand 104 is shown in FIG. 2A. As shown, stand 104 may comprise a lower base 114 and an upper shelf 116 located substantially above lower base 114 during use. Separating lower base 114 and upper shelf 116, and supporting upper shelf 116, may be any number of supports 118. For example, in the embodiment shown, two supports, 118a and 118b may extend between base 114 and upper shelf 116. A cross member 120 may also extend between supports 118a and 118b, to provide additional reinforcement support.

FIG. 2B illustrates a side, cross-sectional view of stand 104, in various embodiments. As shown, base 114 may include a top surface 140 and an opposing, bottom surface 142. Extending from top surface 140 and towards the plane of bottom surface 142 may be a tapered end 128 that allows a robotic vacuum to ascend onto base 114 and into charging station 106. In addition, in one embodiment, base 114 may also include a flat back surface 144, allowing stand 104 to be positioned flush with a wall or other flat surface.

In some embodiments, supports 118a and 118b may each comprise a mating of brackets 124 and 126 via fasteners 122, such as fasteners 122c-122e shown. For example, bracket 124 may be an L-shaped bracket with one end coupled to shelf 116 via one or more fasteners (e.g., fasteners 122a and 122b) that extend into and/or through shelf 116. Similarly, bracket 126 may be of any suitable shape and extend into and/or through base 114. In other embodiments, bracket 126 may be an L-shaped bracket coupled to the top of base 114. In cases in which a cross member 120 is used between supports 118a-118b, as shown, a fastener 122c may also extend through brackets 124-126 and cross member 120, to couple cross member 120 to the supports 118a-118b.

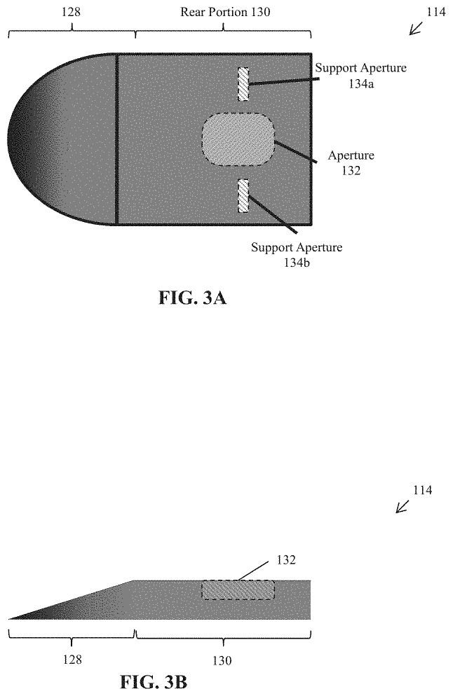

FIGS. 3A-3B illustrate top and side views of base 114, in various embodiments. As shown, base 114 may include a front portion 128 and a rear portion 130. As noted above, and illustrated in FIG. 3B, front portion 128 may be tapered, so as to form an incline that a robotic vacuum can climb to access its charging station 106. In some cases, as shown in FIG. 3A, forward portion 128 may be rounded and the opposing edge of rear portion 130 may be substantially flat. However, other shapes (e.g., parallelograms, etc.) for base 114 are also contemplated. To further prevent assembly 100 from moving during use, the underside of base 116 (not shown) may be coated with a suitable material, such as rubber.

In some cases, base 114 may define support apertures 134 (e.g., 134a-134b) that extend into and/or through base 114. A bracket 126 that is part of the corresponding support 118 may couple with the corresponding aperture 134.

According to various embodiments, rear portion 130 of base 114 may define an aperture 132 that extends into and/or through base 114 and is shaped to accommodate charging station 106. As would be appreciated different manufacturers and models of robotic vacuums may use differently shaped charging stations. Thus, in one embodiment, aperture 132 may be sized to accommodate a particular make and type of charging station. For example, aperture 132 may have a width of approximately 5.25 inches and a length of approximately 5.75 inches (e.g., +/−up to 0.25 inches), to accommodate iRobot™ charging station model number 4452369 for most models of Roomba™ robotic vacuums. Such an aperture may also have a depth of approximately 1/16 (0.0625) of an inch (e.g., +/−up to ¼ inch), to ensure that charging station 106 is substantially flat with top surface 140 of base 114. In further embodiments, aperture 132 may be sized so as to universally accommodate a wide variety of charging stations. In order to ensure a secure fit with aperture 132, a corresponding spacer for the specific type of charging station 106 in use may be used in conjunction with base 114, in some embodiments.

Base 114 may also be sized appropriately for storage of the robotic vacuum. For example, Roomba vacuums typically vary between 13.3 inches and 13.9 inches wide, meaning that base 114 may have a width equal to, or greater than, these dimensions (e.g., between 13.3 and 14.2 inches).

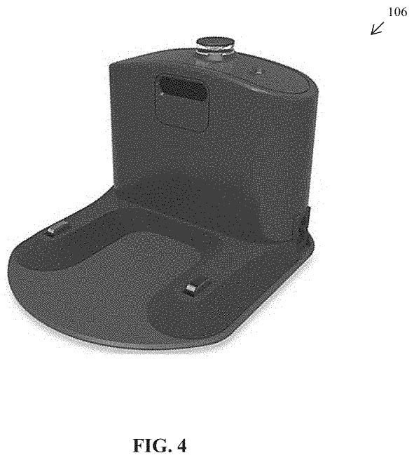

FIG. 4 illustrates an example charging station 104 for a robotic vacuum, in some embodiments. As shown, the robotic vacuum may dock itself to charging station 104, thereby allowing charging station 104 to provide charge to the battery of the robotic vacuum. Also as noted, the shape and size of charging station 104 may vary across manufacturers and/or models and charging station 104 is shown for representative purposes, only.

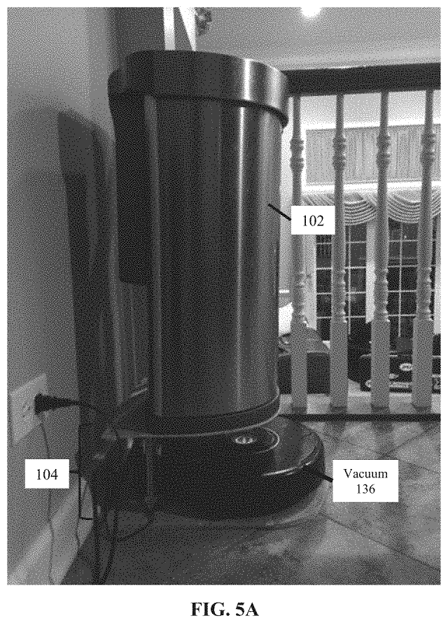

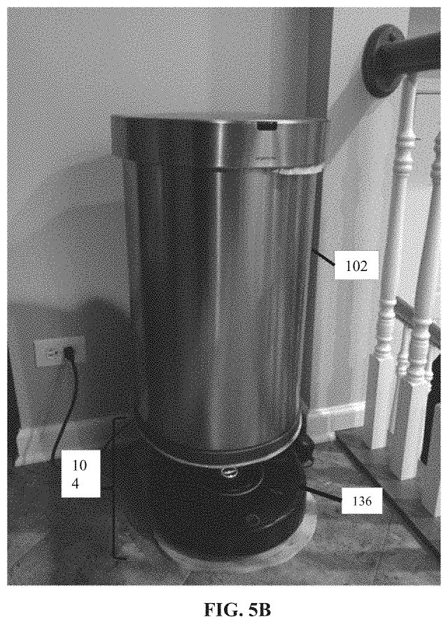

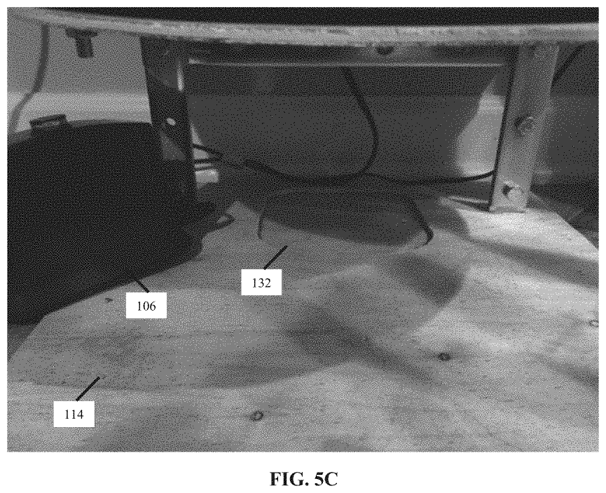

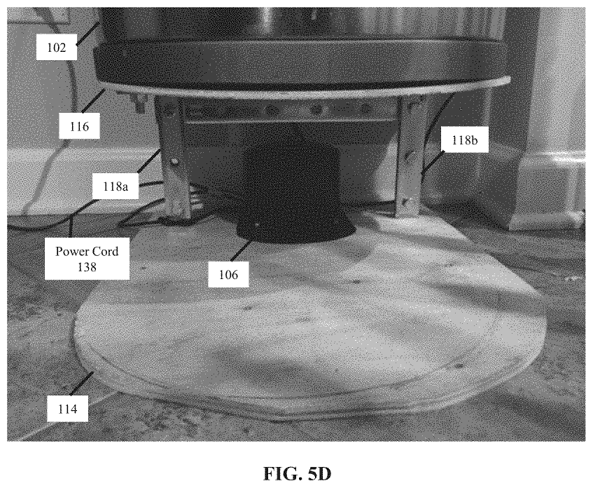

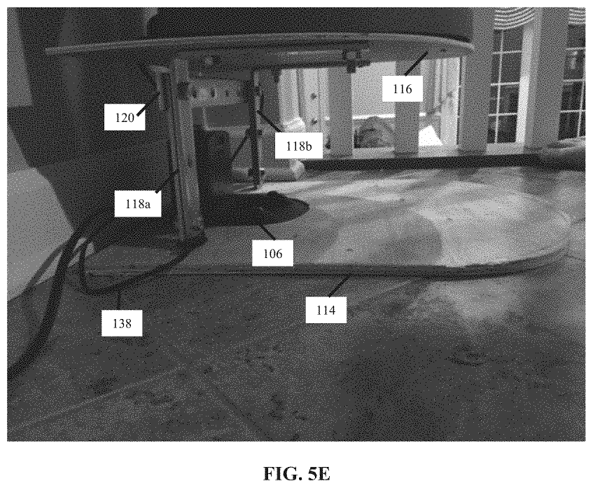

FIGS. 5A-5E illustrate an example prototype of a docking assembly 100 for a robotic vacuum, according to various embodiments. As shown, the prototype assembly 100 was constructed using a Simply Human™ trash bin 102 and a Roomba™ robotic vacuum 136 and corresponding charging station 106. Stand 104 of the prototype assembly 100 was built using plywood for upper shelf 116 and lower base 114. Supports 118a-118b shown were constructed by coupling brackets together using fasteners 118 and with a cross-member 120 coupled between the two supports 118.

FIGS. 5A-5B illustrate side and front perspective views of the prototype assembly 100 with vacuum 136 docked in its charging station 106. While storage container 108 was not included in the prototype assembly 100 shown, one could be added, in further embodiments, behind trash bin 102 on shelf 116. As would be appreciated, shelf 116 and base 114 may be spaced to afford suitable clearance to robotic vacuum 136 when docked and allow the sensors of vacuum 136 to function properly. For example, while vacuum 136 shown is only approximately four inches tall, eight inches or more of clearance may be required for the infrared (IR) sensors of vacuum 136 to properly direct vacuum 136 onto, and off of, base 114 and charging station 106.

FIG. 5C illustrates base 114 of the prototype assembly 100 with charging station 106 removed from the aperture 132 of base 114. In the configuration shown, aperture 132 may be sized so as to provide a stable and snug fit for base 114 and present a substantially level and continuous surface to vacuum 136. In other words, the depth of aperture 132 was selected such that charging station 106 is substantially flush with the top surface of base 114, to prevent vacuum 136 from becoming stuck when docking and undocking from charging station 106.

FIGS. 5D-5E illustrate front and side views, respectively, of the prototype assembly 100 with charging station 106 installed into aperture 132 of base 114. In FIG. 5D, particularly, power cord 138 of charging station 106 may be routed such that any slack can be removed by wrapping power cord 138 around one or both supports 118. In embodiments that include a storage container 108, this excess portion of power cord 138 may alternatively be placed inside storage container 108.

As would be appreciated, the lengths of supports 118a-118b may be selected as desired, to accommodate the height of charging station 106 and/or vacuum 136. For example, newer charging stations also include storage bins and a self-cleaning mechanism that empties bin of vacuum 136 automatically. Thus, shelf 116 and base 114 may be separated by at least the height of the charging station 106 and may further be separated by a suitable distance to allow a user to empty the storage bin(s) of the charging station, if so equipped.

In addition, as shown particularly in FIG. 5E, the length of shelf 116 relative to that of base 114 may be selected, depending on the dimensions of the trash bin 102 and whether shelf 116 also includes a storage container 108. For example, in one embodiment, shelf 116 and base 116 may be of equal lengths. In another embodiment, base 116 may be of greater length than that of shelf 114, to provide additional support. Of course, in a further embodiment, shelf 114 may also have a length greater than that of base 116, as well.

Accordingly, the techniques disclosed herein introduce a docking assembly for use with a robotic vacuum that reduces the potential tripping hazard represented by traditional vacuum charging stations. The additional weight of the docking assembly also helps to prevent the shifting of the charging station when the vacuum docks or undocks from the charging station. Such shifting has been observed when bare charging stations are used, whereby the vacuum inadvertently pushes the station, thereby requiring manual intervention. In further aspects, the techniques herein also provide for storage means for the cord of the charging station, vacuum accessories, and/or other cleaning supplies. Further, some embodiments also include or provide for the placement of a trash bin within close proximity of the docked vacuum, allowing the user to easily empty the vacuum when needed.

The foregoing description has been directed to specific embodiments. It will be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. An apparatus, comprising:
a base having a top surface that defines an aperture sized to mate with a charging station of a robotic vacuum;
one or more supports extending substantially perpendicular from the surface of the first base; and
a shelf supported by the one or more supports that extends parallel to the surface of the base.

2. The apparatus as in claim 1, wherein the aperture extends from the top surface of the base into the base such that the charging station forms a substantially flat and continuous surface with the top surface of the base.

3. The apparatus as in claim 1, wherein an end of the base is tapered to extend from the top surface of the base towards a plane of a bottom surface of the base.

4. The apparatus as in claim 1, further comprising:
a storage container coupled to the shelf.

5. The apparatus as in claim 4, wherein the storage container comprises a hinged lid.

6. The apparatus as in claim 4, wherein the storage container defines a cord aperture extending through at least one wall of the storage container.

7. The apparatus as in claim 4, wherein the storage container is removably coupled to the shelf.

8. The apparatus as in claim 1, further comprising:
a trash bin supported by the shelf.

9. The apparatus as in claim 8, wherein the trash bin is fastened to the shelf.

10. The apparatus as in claim 8, wherein the trash bin is removably coupled to the shelf.

11. The apparatus as in claim 1, wherein the one or more supports extending substantially perpendicular from the surface of the first base comprise a first support and a second support, and wherein the apparatus further comprises:
a cross member coupled to the first and second supports.

12. The apparatus as in claim 1, wherein each of the one or more supports extending substantially perpendicular from the surface of the first base each comprises:
a first bracket extending at least partially into the base; and
a second bracket fastened to the shelf and to the first bracket.

13. The apparatus as in claim 1, wherein the base comprises a flat back surface.

14. The apparatus as in claim 1, further comprising the charging station of the robotic vacuum.

15. The apparatus as in claim 14, further comprising the robotic vacuum.

16. The apparatus as in claim 1, wherein the aperture has a width of approximately 5.25 inches and a length of approximately 5.75 inches.

17. The apparatus as in claim 16, wherein the aperture has a depth of approximately 0.0625.

18. The apparatus as in claim 1, wherein the base has a length greater than a length of the shelf.

19. The apparatus as in claim 1, wherein the shelf and base are of equal lengths.

20. The apparatus as in claim 1, wherein the base has a width between 13.3 and 14.2 inches.
